(19) United States
(12) Patent Application Publication
(10) Pub. No.: US 2011/0293173 A1
(43) Pub. Date: Dec. 1, 2011

(54) Object Detection Using Combinations of Relational Features in Images

(76) Inventors: Fatih M. Porikli, Watertown, MA (US); Vijay Venkatarman, Tulsa, OK (US)

(21) Appl. No.: 12/786,648

(22) Filed: May 25, 2010

(51) Int. Cl. G06K 9/62

(52) U.S. Cl. 382/159

(57) ABSTRACT

A classifier for detecting objects in images is constructed from a set of training images. For each training image, features are extracted from a window in the training image, wherein the window contains the object, and then randomly sample coefficients c of the features. N-combinations for each possible set of the coefficients are determined. For each possible combination of the coefficients, a Boolean valued proposition is determined using relational operators to generate a propositional space. Complex hypotheses of a classifier are defined by applying combinatorial functions of the Boolean operators to the propositional space to construct all possible logical propositions in the propositional space. Then, the complex hypotheses of the classifier can be applied to features in a test image to detect whether the test image contains the object.

### FIELD OF THE INVENTION

This invention relates generally to computer vision, and more particularly to detecting objects in images.

### BACKGROUND OF THE INVENTION

Object detection remains one of the most fundamental and challenging tasks in computer vision. Object detection requires salient region descriptors and competent binary classifiers that can accurately model and distinguish the large pool of object appearances from every possible unrestrained non-object backgrounds. Variable appearance and articulated structure, combined with external illumination and pose variations, contribute to the complexity of the detection problem.

Typical object detection methods first extract features, in which the most informative object descriptors regarding the detection process are obtained from the visual content, and then evaluate these features in a classification framework to detect the objects of interest.

Advances in computer vision have resulted in a plethora of feature descriptors. In a nutshell, feature extraction can generate a set of local regions around interest points, which encapsulate valuable information about the object parts and remain stable under changes, as a sparse representation.

Alternatively, a holistic dense representation can be determined inside the detection window as the feature. Then, the entire input image is scanned, possibly at each pixel, and a learned classifier of the object model is evaluated.

As the descriptor itself, some methods use intensity templates, and principal component analysis (PCA) coefficients. PCA projects images onto a compact subspace. While providing visually coherent representations, PCA tends to be easily affected by the variations in imaging conditions. To make the model more adaptive to changes, local receptive field (LRF) features are extracted using multi-layer perceptrons. Similarly, Haar wavelet-based descriptors, which are a set of basis functions encoding intensity differences between two regions are popular due to efficient computation and superiority to encode visual patterns.

Histogram of gradient (HOG) representations and edges in spatial context, such as scale-invariant feature transform (SIFT) descriptors, or shape contexts yield robust and distinctive descriptors.

A region of interest (ROI) can be represented by a covariance matrix of image attributes, such as spatial location, intensity, and higher order derivatives, as the object descriptor inside a detection window.

Some detection methods assemble detected parts according to spatial relationships in probabilistic frameworks by generative and discriminative models, or via matching shapes. Part based approaches are in general more robust for partial occlusions. Most holistic approaches are classifier methods including k-nearest neighbors, neural networks (NN), support vector machines (SVM), and boosting.

SVM and boosting methods are frequently used because they can cope with high-dimensional state spaces, and are able to select relevant descriptors among a large set.

Multiple weak classifiers trained using AdaBoost can be combined to form a rejection cascade such that if any classifier rejects a hypothesis, then the hypothesis is considered a negative example.

In boosted classifiers, the terms “weak” and “strong” are well defined terms of art. Adaboost constructs a strong classifier from a cascade of weak classifiers, see U.S. Pat. Nos. 5,819,247 and 7,610,250. Adaboost provides an efficient method due to the feature selection. In addition, only a few classifiers are evaluated at most of the regions due to the cascaded structure. An SVM classifier can have false positive rates of at least one to two orders of magnitude lower at the same detection rates than conventional classifiers trained using densely sampled HOGs.

Region boosting methods can incorporate structural information through the sub-region, i.e. weak classifier, selection process. Even though those methods enable correlating each weak classifier with a single region in the detection window, they fail to encapsulate the pair-wise and group-wise relations between two or more regions in the window, which would establish a stronger spatial structure.

In relational detectors, the term n-combinations refers to a set of n distinct values. These values may correspond to pixel indices in the image, bin indices in a histogram based representation of the image, or vector indices of a vector based representation of the image. For example, the feature characterized is the intensity values of the corresponding pixels in case of using pixel indices. An input mapping is then obtained by forming a feature vector of the intensity values sampled at certain pixel combinations.

Generally, the relational detector can be characterized as a simple perceptron in a multilayer neural network, and used mainly for optical character recognition via binary input images. The method has been extended to gray values, and a Manhattan distance is used to find the closest n-combination pattern during the matching process for face detection. However, all these approaches strictly make use of the intensity (or binary) values, and do not encode comparative relations between the pixels.

A similar method uses sparse features, which include a finite number of quadrangular feature sets called granules. In such a granular space, a sparse feature is represented as the linear combination of several weighted granules. These features have certain advantage over Haar wavelets. They are highly scalable, and do not require multiple memory accesses. Instead of dividing the feature space into two parts as for Haar wavelets, the method partitions the features into finer granularity, and outputs multiple values for each bin.

### SUMMARY OF THE INVENTION

The embodiments of the invention provide a method for detecting an object in an image. The method extracts combinations of coefficients of low-level features, e.g., pixels, from and image. These can be n-combinations up to a predetermined size, e.g., doublets, triplets, etc. The combinations are operands for the next step.

Relational operators are applied to the operands to generate a propositional space. The operators can be a margin based similarity rule over each possible pair of the operands. The space of relations constitutes a proposition space.

For the propositional space, combinatorial functions of Boolean operators are defined to construct complex hypotheses to model all possible logical proposition in the propositional space.

In case the coefficients are associated with the pixel coordinates, a higher order spatial structure can be encapsulated within an object window. By using a feature vector instead of pixels, an effective feature selection mechanism can be imposed.

The method uses a discrete AdaBoost procedure to iteratively select a set of weak classifiers from these relations. The weak classifiers can then be used to perform very fast window based binary classification of objects in images.

For the task of classifying images of faces, the method speed up detection about seventy times when compared with a classifier based on a Support Vector Machine (SVM) with Radial Basis Functions (RBF), while reducing a false alarm by about an order of magnitude.

To address the shortcomings of the conventional region features, we use the relational combinatorial features, which generated from combinations of low-level attribute coefficients, which may directly correspond to pixel coordinates of the object window or feature vector coefficients representing the window itself, up to a prescribed size n (pairs, triplets, quadruples, etc).

We consider these combinations as operands of the next stage. We apply relational operators such as margin based similarity rule over each possible pair of these operands. The space of relations constitutes a proposition space. From this space, we define combinatorial functions of Boolean operators, e.g., conjunction and disjunction, to form complex hypotheses. Therefore, we can produce any relational rule over the operands, in other words, all the possible logical proposition over the low-level descriptor coefficients.

In case these coefficients are associated with pixel coordinates, we encapsulate higher order spatial structure information within the object window. Using a descriptor vector instead of pixel values, we effectively impose feature selection without any computationally prohibitive basis transformations, such as PCA.

In addition to providing a methodology to encode the relations between n pixels on an image (or n vector coefficients), we employ boosting to iteratively select a set of weak classifiers from these relations to perform very fast window classification.

Our method is significantly different from the prior art as we explicitly use logical operators with a learned similarity thresholds as opposed to raw intensity (or gradient) values.

Unlike the sparse features or associated pairings, we can extend the combinations of the low-level attributes to multiples of operands to gain better object structure imposition on the classifiers we train.

### BRIEF DESCRIPTION OF THE DRAWINGS

FIG. 1 is a block diagram of a method and system for detecting an object in an image according to embodiments of the invention;

FIGS. 2A-2B are tables of hypothesis according to embodiments of the invention; and

FIG. 3 is a lock diagram of pseudo code for boosting a classifier according to embodiments of the invention.

### DETAILED DESCRIPTION OF THE PREFERRED EMBODIMENTS

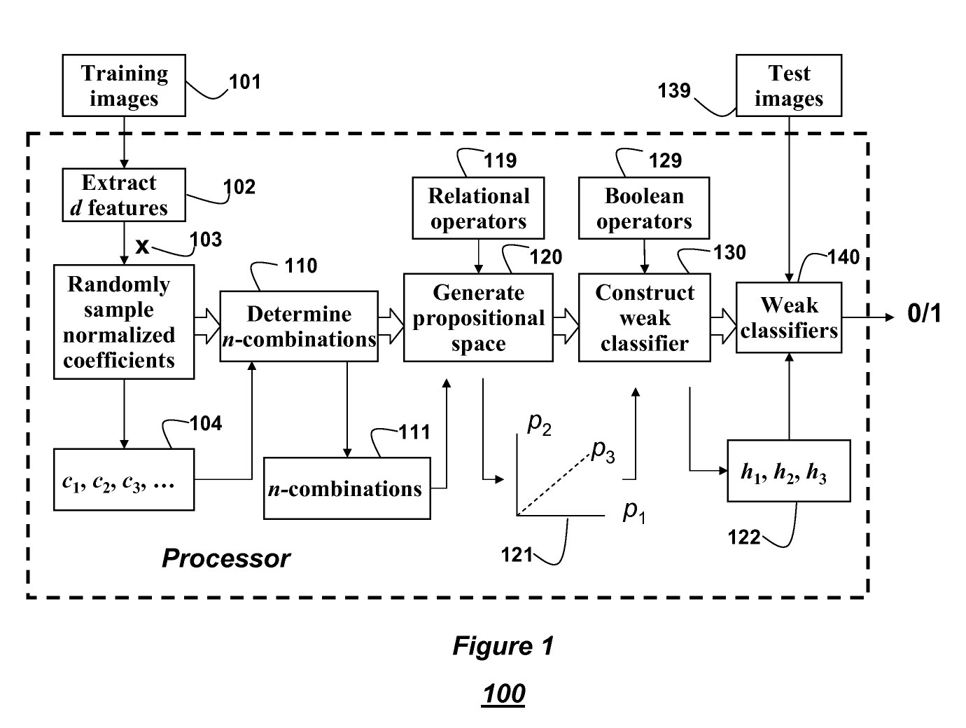

FIG. 1 shows a method and system 100 for detecting an object in an image according to embodiments of our invention. The steps of the method can be performed in a processor including memory and input/output interfaces as known in the art.

We extract 102 d features in a window in a set (one or more) training images 101. The window is part of the image that contains the object. The object window can be part or the entire image. The features can be stored in a d-dimensional vector x 103. The features can be obtained by raster scanning the pixel intensities in the object window. Therefore, d is the number of pixels in the window. Alternative, the features can be a histogram of gradients (HOG). In either case, the features are relatively low-level.

We randomly sample 103 n normalized coefficients 104, e.g., c₁, c₂, c₃, . . . , cₙ, of the features. The number of random samples varies can depend on a desired performance. The number of samples can be in a range of about 10 to 2000.

We determine 110 n-combinations 111 for each possible combination of these sampled coefficients. The n-combinations can be up to a predetermined size, e.g., doublets, triplets, etc. In other words, the combinations can be for 2, 3, or more low level features, e.g., pixel intensities or histogram bins. We take the intensities/values of the pixels or histogram and apply some similarity rule, e.g., Equation (1) below. The final result is either 1 or 0 for the combined features. The combinations are operands for the next step.

For each possible combination of the sampled coefficients 104, we define a Boolean valued proposition pᵢⱼ using relational operators g 119 as pᵢⱼ=g(cᵢ, cⱼ). For instance, a margin based similarity rule gives

$${p}_{ij} = \{ \begin{matrix}1 & \vert {c}_{i} - {c}_{j} \vert \leq τ \\ 0 & otherwise ,\end{matrix} \qquad ( 1 )$$

which can be considered as a type of a gradient operator. In the preferred embodiments, we use Boolean algebra. However, the invention can be extended to non-binary logic, including fuzzy logic. A margin value τ indicates an acceptable level of variation, which is selected to maximize the performance for the classification of the corresponding hypotheses.

In other words, when we apply the relational operators to the operands, we generate 120 a propositional space 121. As stated above, the operators can be the margin based similarity rule over each possible pair of the operands (n-combinations 111). The space of the relations constitutes the propositional space 121.

For the propositional space 121, combinatorial functions of the Boolean operators 129, e.g., conjunction, disjunction, etc., are defined to construct 130 complex hypotheses (h₁, h₂, h₃, . . . ) 122 that model all the possible logical propositions.

In case the coefficients are associated with the pixel coordinates, a higher order spatial structure can be encapsulated within the object window. By using a feature vector instead of pixels, an effective feature selection mechanism can be imposed.

Given n, we can encode a total of

$${k}_{2} = ( \begin{matrix}n \\ 2\end{matrix} )$$

elementary propositions made up of pairs. At this stage, we have mapped the combinations of the coefficients into a Boolean string of length k₂. Higher level propositions result in a

$${k}_{1} = ( \begin{matrix}n \\ 1\end{matrix} )$$

string. In addition, we obtain a transformation from the continuous valued scalar space to a binary valued space.

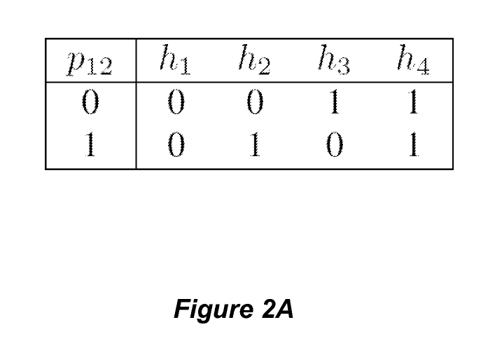

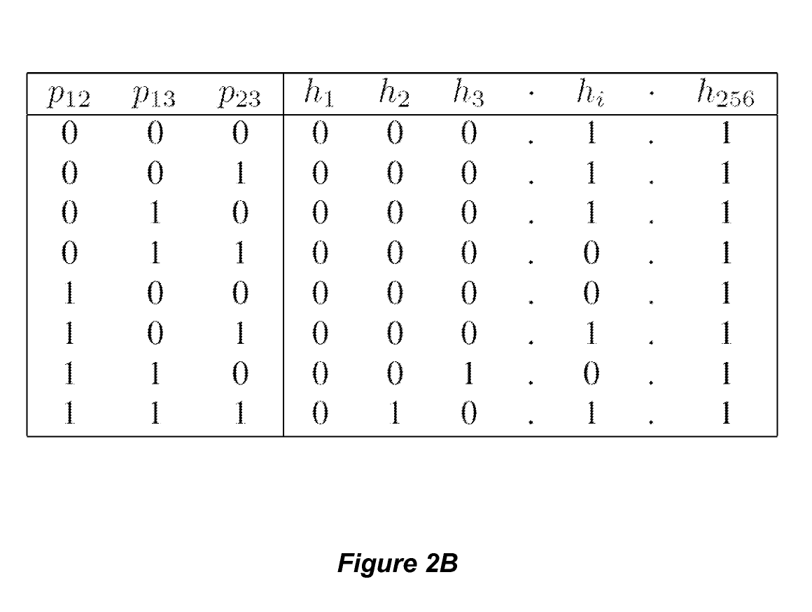

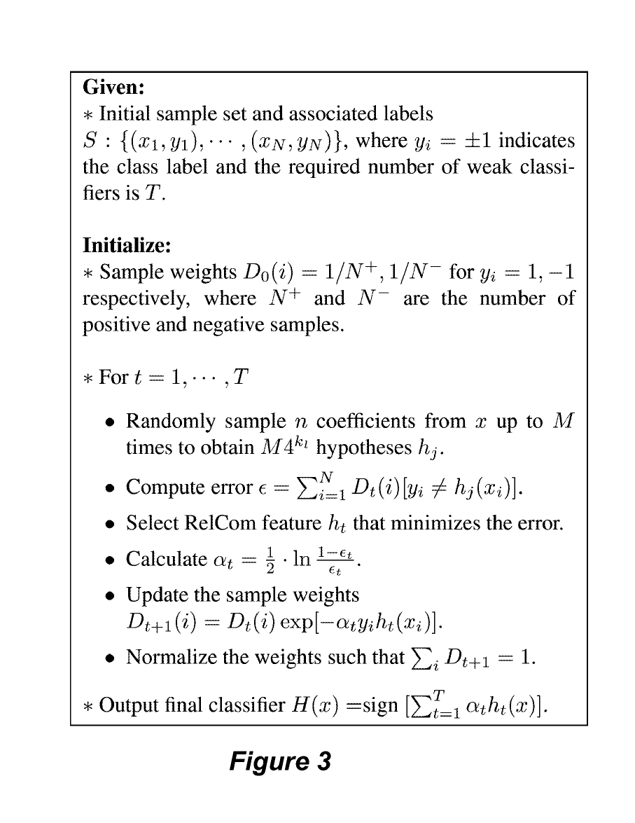

The second combinatorial mapping with the Boolean operators constructs 130 the hypotheses hᵢ that covers all possible 4ₗ^{k} Boolean operators. For example, in case of sampling two coefficients, the four hypotheses are shown in FIG. 3A. Sampling of three coefficient gives 256 hypotheses as shown in FIG. 2B.

Some of the above hypotheses are degenerate and cannot be logically valid, such as the first and last columns. Half of the remaining columns are complements. Thus, when we search within the hypotheses space, we do not need to go through of all 4ₗ^{k} possibilities. The values of the propositions indicate whether a sample is classified as positive (1) or negative (0), see FIG. 1.

Boosting

To select the most discriminative features out of a large pool of candidate features, we use a discrete AdaBoost procedure because the output is binary and nicely fits within the discrete AdaBoost framework. AdaBoost calls a weak classifier repeatedly in a series of rounds. For each call a distribution of weights Dₜ is updated that indicates the importance of examples in the data set for the classification. On each round, weights of each incorrectly classified example are increased, and weights of each correctly classified example are decreased, so that the new classifier focuses more on correctly classified examples.

FIG. 3 shows pseudo-code for our AdaBoost process. This procedure is different than the conventional AdaBoost at the level of the weak classifiers. In our case, the domain of the weak classifiers is in the hypotheses space. Following the discussion above, we randomly sample M times from the input coefficients to obtain M relational combinatorial (RelCom) features, and we evaluate the weighted classification error for each one. We select the one that minimizes the error and update the training sample weights.

Different boosting algorithms can be defined by specifying surrogate loss functions. For instance, LogitBoost determines the classifier boundary is by a weighted regression that fits class conditional probability log ration with additive terms by solbing a quadratic error term. BrownBoost uses a non-monotonic weighting function such that examples far from the boundary decrease in weight and algorithms attempts to achieve the target error rate. GentleBoost update weights with the Euclidean probability difference of hypotheses instead of log ratio, thus the weights are guaranteed to be in [0 1] range.

After the classifier 140 has been constructed, it can be used to detect objects. As shown in FIG. 1, the output of the strong classifier 140 for test image 139 is the sign (0/1) of the sum of the weighted responses of the selected features. For the test image, the features are extracted, randomly selected and combined as exactly as described above for the training images. Thus, our main focus is not so much on the classifiers, but more on our novel relational combinatorial features, which allow to greatly reducing the computational load without sacrificing accuracy, as described below.

Computational Load

The relational operator g has a very simple margin based distance form. Therefore, for the distance norm given in Equation 1, it is possible to construct a 2D lookup table that encode responses for each proposition, and then combine the responses into separate hypotheses 2D lookup tables. For the n-combinations within the complex hypotheses, these lookup tables becomes n-dimensional. Indices to the tables can be pixel intensity values, or a quantized range of vector values depending on the feature representation. In case of a fixed number of discrete feature low-level representations, such as 256 level intensity values, the use of lookup tables provides the exact results of the relational operator g since there is no loss of information, and an insignificant adaptive quantization loss for other feature low-level representations that are not discrete.

As an example, given a 256 level intensity image and a chosen complex hypothesis make use of a 2D relational operator pᵢⱼ=g(cᵢ, cⱼ), we construct a 2D lookup table where the horizontal (cᵢ) and vertical (cⱼ) indices are from 0 to 255. Offline, we compute the relational operator response for all corresponding cᵢ, cⱼ indices and keep it in the table. When we are given a test image to apply the complex hypothesis, we get the intensity values of the feature pixels and directly access to the corresponding table element without actually computing the relational operator output.

Particularly, we can trade the computational load for memory based tables, which are relatively small, e.g., many 100×00 or 256×256 binary tables as the number of features. In case of 500 triplets, the memory for the 2D lookup tables is approximately 100 MB. After obtaining the propositional values from the lookup table, we multiply the binary values with the corresponding weights of the weak classifiers, and aggregate the weighted sum to determine the response.

Therefore, we only use fast array accesses, instead of much slower arithmetic operations, which results in probably the fastest detectors known in the art. Due to vector multiplications, neither SVM RBF, nor linear kernels can be implemented in such a manner.

We can also use a rejection cascade with our boosted classifier. The rejection cascades significantly further decreases the computational load in scanning based detection. The detection can become 750 times faster, and decreasing the effective number of features to be tested from 6000 to a mere 8 on average.

### Effect of the Invention

We describe a detection method that uses combinations of very simple relational features, either from direct pixel intensity or a feature vector of an object window. The method can be used in a boosting framework to construct classifiers that are as competitive as the SVM-RBF, but require only a fraction of the computational load.

Our features can efficiently speed up the detection several orders of magnitude because our method does not require any complex computations because we use 2D lookup tables.

The features are not limited to pixel intensities, e.g., window level features can be used.

We can use higher order relational operators to acquire a more efficiently spatial structure within the object window.

It is to be understood that various other applications and modifications can be made within the spirit and scope of the invention. Therefore, it is the object of the appended claims to cover all such variations and modifications as come within the true spirit and scope of the invention.

We claim:

1. A method for classifying an object in a test image, comprising for each training image in a set of training images the steps of:
extracting features from a window in the training image, wherein the window contains the object;
randomly sample coefficients c of the features;
determining n-combinations for each possible set of the coefficients;
defining, for each possible combination of the coefficients, a Boolean valued proposition using relational operators to generate a propositional space;
constructing complex hypotheses of a classifier by applying combinatorial functions of the Boolean operators to the propositional space to construct all possible logical propositions in the propositional space; and further comprising for only the test image;
applying the complex hypotheses of the classifier to features extracted from the test image to detect whether the test image contains the object, wherein the steps are performed in a processor.

2. The method of claim 1, wherein the coefficients are normalized for the training dataset images and within the test image.

3. The method of claim 1, wherein the features are pixel intensities.

4. The method of claim 1, wherein the features are histograms of gradients.

5. The method of claim 1, wherein the features are the coefficients of a descriptor vector associated with the training images.

6. The method of claim 1, wherein the Boolean valued proposition pᵢⱼ and the relational operators are g, and pᵢⱼ=g(cᵢ, cⱼ).

7. The method of claim 6, wherein the Boolean values proposition is a margin based similarity rule
$${p}_{ij} = \{ \begin{matrix}1 & \vert {c}_{i} - {c}_{j} \vert \leq τ \\ 0 & otherwise ,\end{matrix}$$
where τ is a margin value.

8. The method of claim 1, wherein the Boolean operators include conjunction and disjunction.

9. The method of claim 1, wherein the Boolean operators include non-binary logic operators including operators applied in fuzzy, ternary, and multi-valued logic systems.

10. The method of claim 1, wherein the features are stored in a d-dimensional vector x.

11. The method of claim 1, wherein the classifier is in a form of a boosted learner including variants of AdaBoost, discrete AdaBoost, LogitBoost, BrownBoost, and GentleBoost procedures.

12. The method of claim 1, wherein the logical propositions are encoded in lookup tables of responses for each proposition when applying the complex hypotheses of the classifier.

13. The method of claim 1, wherein each of the constructed complex hypotheses is encoded in n-lookup tables, wherein the lookup tables are n-dimensional.

14. The method of claim 12, wherein the applying the complex hypotheses is done by accessing the lookup tables and aggregating a weighted sum of the responses.

15. The method of claim 12, wherein indices for the lookup tables are within a range of intensity values of pixels in the images.

16. The method of claim 12, wherein the indices for the lookup tables are within a quantized range of vector values.

17. The method of claim 1a, wherein the classifier is a boosted classifier and constitutes a rejection cascade.

18. The method of claim 7, wherein the margin value optimizes a detection performance of a corresponding complex hypothesis on the set of training images.
